(19) United States
(12) Patent Application Publication
(10) Pub. No.: US 2006/0130057 A1
(43) Pub. Date: Jun. 15, 2006

(54) Multiple-party project management system and method

(76) Inventor: Siranjan Kulatilake, Washington, DC (US)

Correspondence Address: STEPTOE & JOHNSON LLP, 1330 CONNECTICUT AVENUE, N.W., WASHINGTON, DC, 20036, US

(21) Appl. No.: 11/281,899

(22) Filed: Nov. 18, 2005

Related U.S. Application Data
(60) Provisional application No. 60/628,554, filed on Nov. 18, 2004.

(51) Int. Cl. G06F 9/445

(52) U.S. Cl. 717/176

(57) ABSTRACT

A computerized system of project management is provided. A plurality of selectable pre-determined project parameters are used and, at least one of the plurality of selectable pre-determined project parameters has an associated follow-up project parameter. A graphical user interface is configured to allow selection from said plurality of selectable pre-determined project parameters, display a chronology object and, in association with the chronology object, at least selected ones of said plurality of selectable pre-determined project parameters and any associated follow-up project parameters. A processor is configured to receive selections of said plurality of selectable pre-determined project parameters and to update the chronology object in substantially real time.

### CLAIM OF PRIORITY

This application claims priority under 35 U.S.C. § 119(e) to U.S. Provisional Application No. 60/628,554 filed Nov. 18, 2004, and is incorporated in its entirety by reference herein.

### TECHNICAL FIELD

The present invention relates generally to the management of projects, tasks, transactions, ventures, or other endeavors. In particular, the present invention relates to the computerized management and coordination of project-specific information or instructions, such as information pertaining to the project's parties, timing and events.

### BACKGROUND

Many projects use and benefit from computer-assisted management. Yet, traditional project management systems and methods can contain inefficiencies and inconveniences that decrease the likelihood of a successful, alacritous, and low-stress outcome. The impact of such inefficiency and inconvenience usually increases with the complexity of the project.

Traditional forms of communication used to coordinate a project that involves two or more parties are subject to each party's schedule. Consequently, the transfer of information can be delayed. It is not uncommon for such undertakings to fall short of their desired goals, exceed budget, or fail to minimize inefficiency and stress. As a result, the goals of the parties in such an environment may not be optimally realized, or thwarted entirely.

For example, in a real estate transaction, the complex relationship between the parties, timing and events can create a Byzantine array of appointments, tasks, scheduled events, deadlines, and meetings. These additional demands can further increase the stress on the parties in what is already an inherently stressful transaction. As an undertaking increases in both complexity and need for communication, so does the likelihood of a breakdown in communication between the parties and, of course, stress from the moment a contract is ratified to its ultimate settlement. This period is characterized by multiple, overlapping, interdependent events of varying duration. During this period the undertaking is at its most fragile because the failure to conclude just one event successfully may negatively impact subsequent events.

Current management systems are not designed to address the problems faced in prolonged, complex multi-party projects. In the example of a real estate transaction, typically an agent, seller, and buyer must collectively manage the transaction through typical communication systems that have an inherent level of delay. As a result, they still had to communicate their information through traditional means. These traditional management tools do nothing to reduce the misinformation and stress caused by communication delays.

### SUMMARY

A system and method of managing complex projects and coordinating complex processes between multiple parties is needed. For example, a typical real estate transaction is a high stress, complex process typically accomplished through an assortment of communication systems, luck and stress. Typical communication systems are decentralized, limited as to global access, subject to the availability of another party, and have an inherent delay. This delay, in turn, can lead to one party being unaware of new information and foster increased inefficiency, stress, and/or delay. In extreme cases, each of the aforementioned failings, without limitation, can contribute, in whole or in part, to the ultimate failure of one or more goals of the undertaking. Thus, the current state of the art lacks a centralized system and method of managing complex projects and coordinating complex processes between multiple parties. A single, unified system and method that can be accessed by more than one party to the venture, at anytime, anywhere in the world, is needed.

In general, a method and system of project management includes the substantially real-time, interactive management of a project or transaction by multiple parties related to the transaction from anywhere, at anytime.

In one aspect of the invention, a computerized system of project management is provided. A plurality of selectable pre-determined project parameters are used and, at least one of the plurality of selectable pre-determined project parameters has an associated follow-up project parameter. A graphical user interface is configured to allow selection from the plurality of selectable pre-determined project parameters, display a chronology object and, in association with the chronology object, at least selected ones of the plurality of selectable pre-determined project parameters and any associated follow-up project parameters. A processor is configured to receive selections of the plurality of selectable pre-determined project parameters and to update the chronology object in substantially real time.

In another aspect of the invention, a method of managing a project is provided. A plurality of selectable pre-determined project parameters are provided, and at least one of the plurality of selectable pre-determined project parameters has an associated follow-up project parameter. The method also includes selecting, through a graphical user interface, from amongst the plurality of selectable pre-determined project parameters. The method can further include displaying a chronology object and in association with the chronology object, at least selected ones of the plurality of selectable pre-determined project parameters and associated follow-up project parameters. The method can also include updating the chronology object in substantially real time based on the selecting.

The system and method can also include a display object on the graphic user interface. The display object can include, by way of non-limiting example, a task manager or an appointments manager. The graphical user interface can be further configured to display only those selected ones of the plurality of selectable pre-determined project parameters for which at least one party is responsible.

The system and method can also include managing a project where the project is a transaction, for example a real estate transaction. However, the project can also be any task, process, venture, undertaking or other chronology of events that inter-relate multiple parties to achieve a common goal.

The system and method can include a graphical interface that can further include a chronology object that is, by way of non-limiting example, a timeline or calendar. The system and method can also include an alternate view mode, and can be configured so that each view mode permits the user to access a graphic user interface that can receive a user-defined project parameter and to display the user-defined project parameter in association with the chronological object. The system and method can then include a processor wherein the processor is configured to receive any user-defined project parameter and to update the chronological object in substantially real time.

Advantageously, the system and method can increase the likelihood of a successful, low stress conclusion to a project by enabling a multi-user enabled, web accessed, virtually real time tool for establishing, maintaining, updating and visually representing in text and graphical form the progress of a prolonged and complex project, process, or transaction.

The details of one or more embodiments are set forth in the accompanying drawings and in the descriptions below. Other features, objects, and advantages will be apparent from the drawings, from the descriptions, and from the claims.

### DESCRIPTION OF THE DRAWINGS

The present invention is further described in the detailed description which follows, in reference to the noted plurality of drawings by way of setting forth the preferred embodiment of the present invention, and wherein:

FIG. 1 depicts an implementation of the invention,

FIG. 2 depicts an implementation of a GUI used in the system,

FIG. 3 depicts an implementation of a project parameter window,

FIG. 4 depicts an implementation of a project parameter window,

FIG. 5 depicts an implementation of a timeline object,

FIG. 6 depicts another implementation of a GUI used in the system,

FIG. 7 depicts yet another implementation of a GUI used in the system, and

FIG. 8 depicts an implementation of a GUI used in an alternate view mode.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

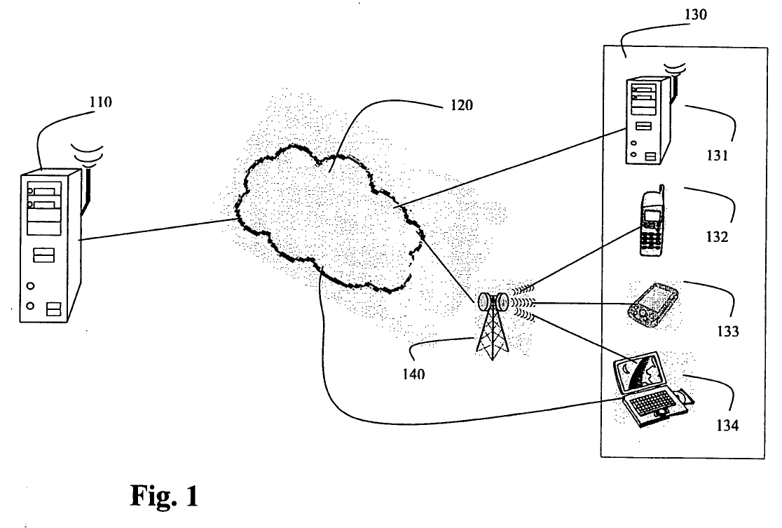

Referring now to FIG. 1, processor 110, such as a server, connects to network 120, such as the Internet or an Intranet. Network 120 connects to a variety of user interfaces 130 such as a desktop computer 131, mobile telephone 132, personal digital assistant (PDA) 133, laptop 134, etc. The software program for the invention preferably resides on processor 110, and the underlying information is communicated over network 120 with and between the user interfaces 130 for display and processing on their local terminals.

The program includes a set of pre-programmed selectable project parameter options. A project parameter is a specific task or event associated with the project. For example, in a real estate transaction, a project parameter can be, by way of non-limiting example, a contract offer, a settlement, an inspection, a closing, mortgage application filing, a mortgage application acceptance, etc. The program will also allow the user to create unique project parameters that are not pre-programmed.

Individual project parameters may have pre-set time periods associated therewith. For example, the law of a particular state may require that an inspection take place within 14 days of the contract signing. Thus, by selecting a contract signing as a task and assigning a date thereto, the program automatically establishes the inspection as a follow-up task to occur within 14 days from the selected date. The program will also allow the user to create unique follow-up tasks and/or unique follow-up periods. Some tasks, e.g., the last task of the project, will require no follow-up at all. The program can calculate dates, schedule events and/or make any other project related calculation that will enable the tool to effectively manage the project, or a portion of the project.

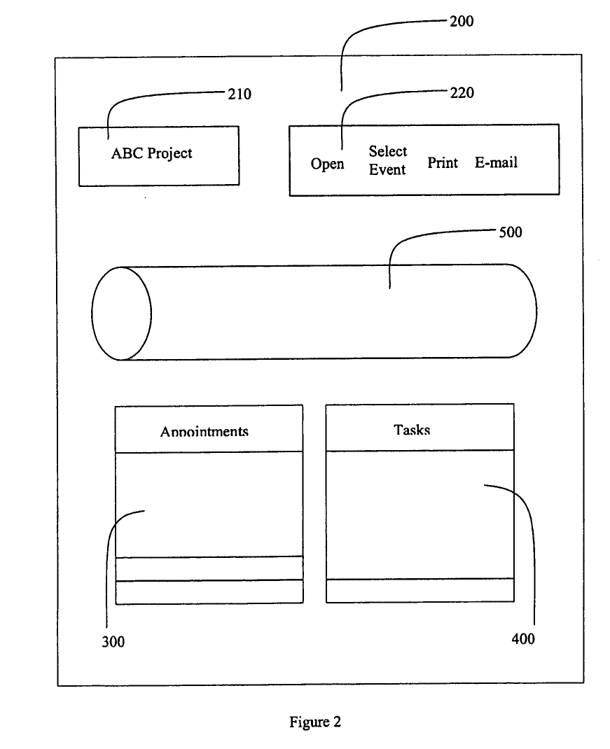

Processor 110 can cooperate with the individual user interfaces to provide a graphical user interface (“GUI”). Referring now to FIG. 2, GUI 200 preferably displays certain information about the transaction fields for entry and/or manipulation of transaction date, such as appointments window 300, task window 400, or any other device for facilitating the central management of particular project parameters. GUI 200 also displays a chronology object 500 such as a timeline or calendar.

As a particular user selects particular project parameters, processor 110 in cooperation with interface 130 updates GUI 200 in substantially real time (i.e., in real time subject to the natural delay of electronic equipment to receive, process, send and/or display information) such that a specific task will appear on GUI 200 with, for example, a specific completion date. If there is a follow-up task(s), processor 110 will update GUI 200 to display the follow-up task(s) with its target completion date(s). Note that updating GUI 200 preferably includes updating chronology object 500. Updating GUI 200 can also include, by way of non-limiting example, updating appointments window 300 and tasks window 400.

Tasks which are specific to certain parties in a transaction may be so designated with appropriate labeling. For example, buyer related tasks may be indicated in green, and seller related tasks may be indicated in red. GUI 200 can provide the user with the option of displaying the tasks of only certain selected parties to the exclusion of other parties. This may be useful, for example, to allow a buyer to only see tasks that the buyer must perform to avoid confusion with tasks that the seller must perform.

Access to the program is preferably limited to the parties to the transaction, or a subset thereof. In the case of the real estate transaction, this would include the buyer, seller, and real estate agents. In the alternative, if the service is provided by the real estate agent, it may be desirable for only that agent and his client to have access.

Modification privileges for the underlying data may be available to all parties to the transaction or a subset thereof. Such modification privileges may be reserved for the party or parties responsible for maintaining the data. In the real estate context, the real estate agents would have access, but the client may or may not to prevent accidental tampering with the data.

GUI 200 preferably includes a variety of graphic objects or fields, such as text objects 210, toolbar objects 220, and windows objects 300, 400. Text object 210 may include without limitation the name of the project, name of user, address, or the name of the property in the case of a real estate transaction. Toolbar object 220 can include, without limitation, text or icons for managing the system or method itself, as opposed to managing the project directly. For example, the toolbar object can allow a user to perform certain project-related, or system-related functions such as open, close, save, print, e-mail, update, undo, or any other such function. A windows object 300, 400 can be, by way of non-limiting example, an appointments window, task window, or any other device for facilitating the central management of one or more particular project parameters. The graphical objects are not limited to those mentioned and, indeed, can be any object that serves the particular implementation of the invention.

GUI 200 can be rendered in for example, hypertext/xml/wap, Flash, JAVA, AJAX, but is not limited thereto. Display of the GUI can be implemented in various information processing systems or devices such as, but not restricted to, a desktop computer, a TV set top box, a mobile computer, PDA, and web enabled phone by a wireless or wire line communication link. Users may interact with GUI 200 through any computer peripheral equipment, such as a keyboard, mouse, and electronic stylus.

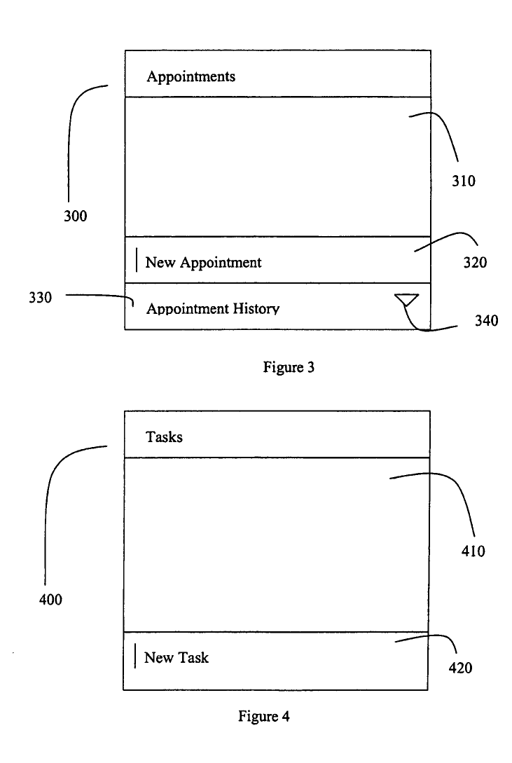

FIGS. 3 and 4 depict implementations of a window object. A window object can display, manage, or otherwise coordinate any information or parameter that relates to a project. FIG. 3 depicts appointments window 300. Appointments window 300 can further include a main appointment area 310 for displaying current, upcoming, or user-chosen information. Appointments window 300 can also include one or more interactive elements 340, used to manipulate the window, create pop-up windows, drop-down menus, or any other interactive element to facilitate manageability such as an appointments history window 330 or an appointment input element 320 for entering a new appointment.

Similarly, FIG. 4 depicts a tasks window 400 for displaying information related to the tasks or events particular to a project. The tasks window can include, for example, an area for displaying current tasks 410 or entering new tasks 420.

Once tasks are completed, a user can update the status through GUI 200. The completed tasks can then be removed from chronology object 500. In the alternative, the completed tasks can remain on chronology object 500 with some indication that the tasks have been completed, e.g., a “completed” label, shading or coloring of the task. Processor 110 also auto-updates any dates as necessary based on a completed task. For example, as of October 1, task A must be completed within 14 days by October 14, and then task B must be completed 14 days later by October 28. If task A is completed on October 9, then the program auto-updates task B to be completed 14 days thereafter on October 23.

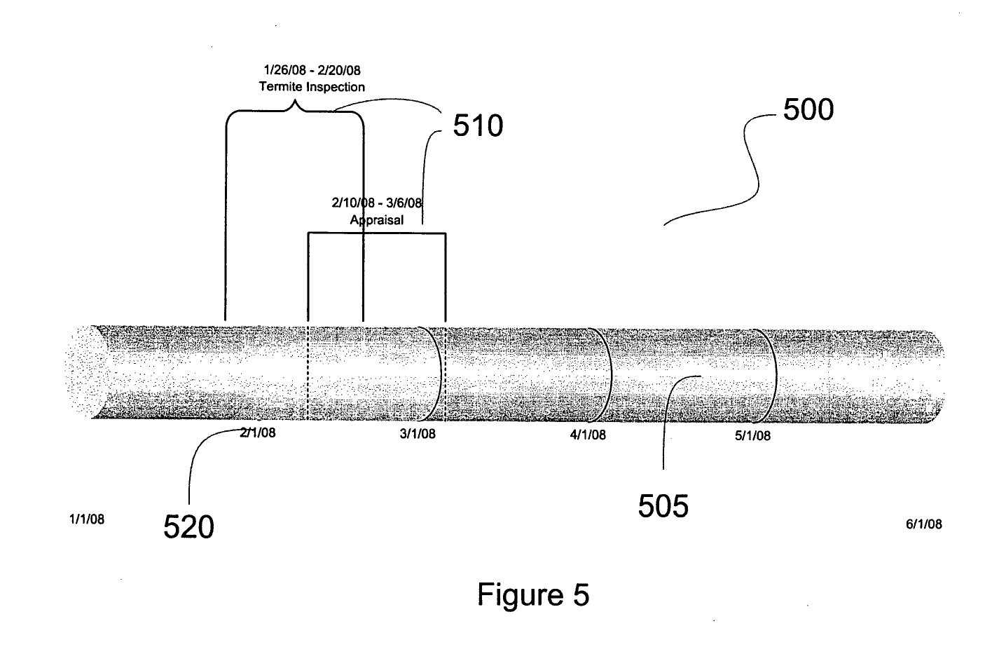

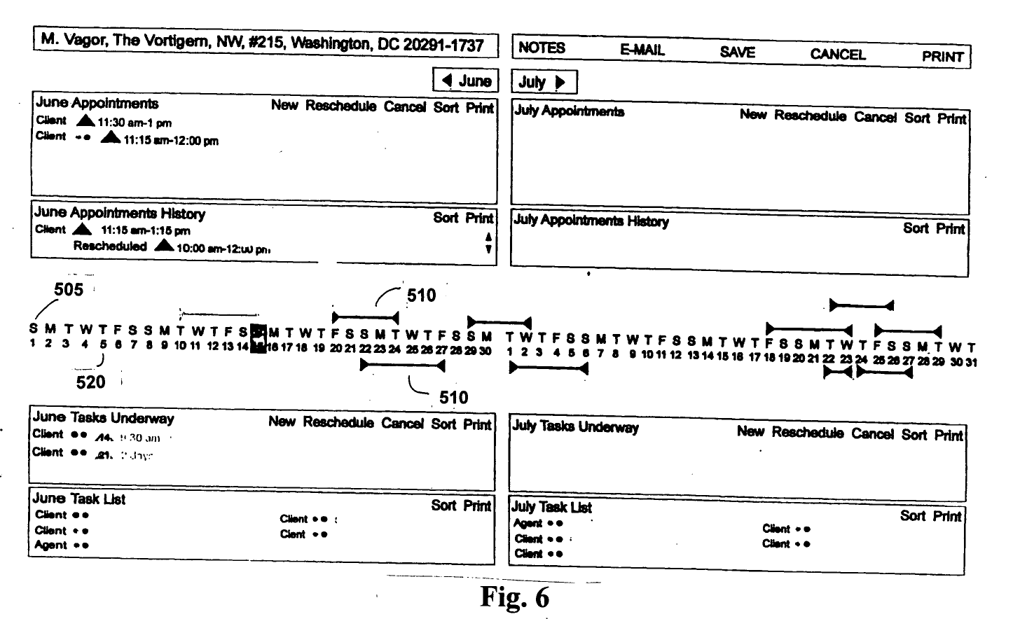

Referring now to FIG. 5, chronology object 500 can be, for example, a timeline 505. Task time periods may be shown by, for example, corollary sub-timelines 510. Examples of sub-timelines can also be seen in FIG. 6, in which timeline 505 is implemented as a continuous, two dimensional distribution of dates 520, representing, in this instance, two consecutive months on a horizontal plane with abbreviated day names located above each date. Timeline 505 is populated by a plurality of overlapping time periods 510. Time periods 510 represent events, task, appointments or any other project parameter particular to the project.

Timeline 505 can be scrolled left and right to view past and future time periods. Based on the length of the project, it may not be possible to show the entire chronology object 500 on a single screen, either alone or in combination with other objects on the screen. The program allows the user, through GUI 200, to shift through chronology object 500 so that a specific activity period can be shown, e.g., a two-month window within a four month timeline. The spacing of time divisions on the timeline can be reduced or expanded to show more or less of an activity period, although certain tasks and/or information may not be displayable based on limited screen space. The timeline may also be displayed over multiple lines on a single screen.

Each event on the Timeline can have one or more properties, for example:
double headed arrows accompanied by a text legend;
a tri-state, color coded status attribute that can be updated;
can be probed to reveal overlap times with other events;
drag and drop capability along the timeline; and
drag and drop capability on to other windows.

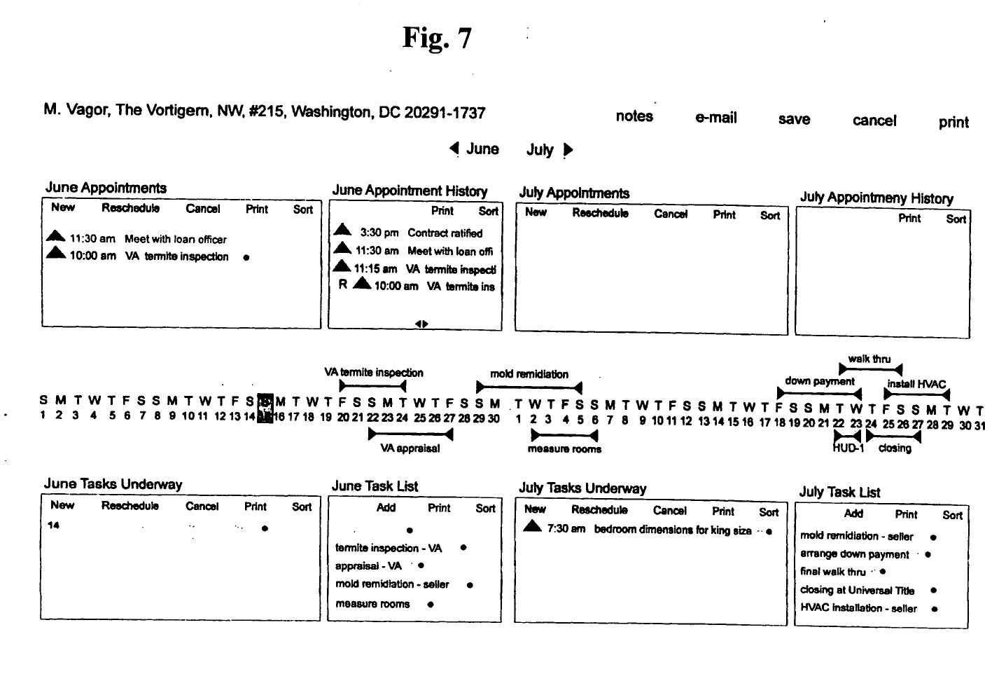

GUI 200 can be manipulated to suit the needs of the current user. For example, if desirable in a certain implementation, it is possible to create a window object oriented view where selected window objects are enlarged, perhaps containing icons, while other window objects are removed. An illustration of this can be seen in FIGS. 6 and 7, depicting examples of other GUIs, and demonstrating the flexibility of the invention.

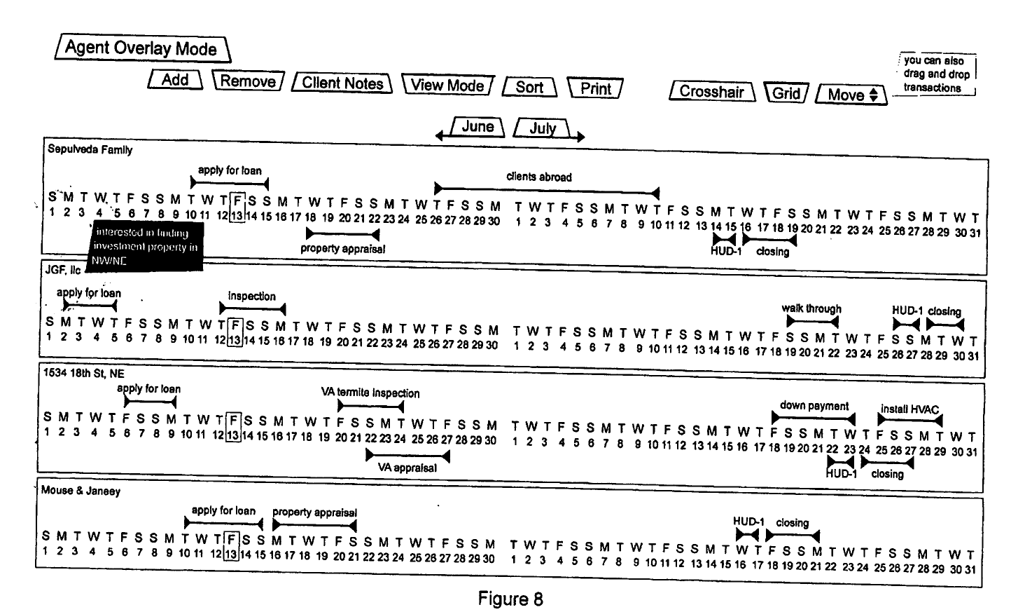

In another aspect of the system and method, a user can switch view modes, or modes of display of project parameters. FIG. 8 depicts an alternate view that overlays a plurality of timelines 505. All of the implementations disclosed above generally refer to view mode common to many or all users related to a project. They all have in common the presence of one chronology object 500 because they manage one project. All of the additional graphical objects also serve that same project.

By way of comparison, FIG. 8 illustrates an alternate view mode. By way of non-limiting example, consider an implementation that includes a more prolonged, complex project or transaction taking place simultaneously. In that instance, the user simply needs to switch to a view mode that aggregates one or more project parameters, for example, chronology object 500 as depicted in FIG. 8. Thus a user in an alternate view mode can view a plurality of, e.g., timelines 505, each representing a different project or set of projects. This will enable the user to, at a glance, see any potential conflicts, pitfalls, or opportunities.

Such an alternate view mode can further streamline an undertaking, or set of undertakings, resulting in a more efficient, less stressful, process that provides additional stability over the prior art when managing one or many prolonged, complex projects. As a result, transactions will be less likely to fail for the reasons stated above and, in addition, the entire project will be less stressful and more enjoyable for all parties.

While the above implementations have been discussed in the context of a real estate transaction, the invention is not so limited. Non-limiting examples of other possible implementations are construction projects, court docketing management, and home improvement project management.

It is noted that the foregoing examples have been provided merely for the purpose of explanation and are in no way to be construed as limiting of the present invention. While the present invention has been described with reference to certain implementations, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and implementations, the present invention is not intended to be limited to the particulars disclosed herein; rather, the present invention extends to all functionally equivalent structures, methods and uses, such as are within the scope of the claims as may be appended.

What is claimed is:

1. A computerized system of project management comprising:
a plurality of selectable pre-determined project parameters; at least one of said plurality of selectable pre-determined project parameters having an associated follow-up project parameter;
a graphical user interface configured to:
allow selection from said plurality of selectable pre-determined project parameters;
display a chronology object; and
display, in association with the chronology object, at least selected ones of said plurality of selectable pre-determined project parameters and any associated follow-up project parameters;
a processor configured to receive selections of said plurality of selectable pre-determined project parameters and to update the chronology object in substantially real time.

2. The system of claim 1, further comprising a display object on said graphic user interface.

3. The system of claim 2, wherein said display object includes a task manager.

4. The system of claim 2, wherein said display object includes an appointments manager.

5. The system of claim 1, wherein the graphical user interface is further configured to display only those selected ones of said plurality of selectable pre-determined project parameters for which at least one party is responsible.

6. The system of claim 1, wherein the project is a transaction.

7. The system of claim 6, wherein the transaction is a real-estate transaction.

8. The system of claim 1, wherein the chronology object is a timeline.

9. The system of claim 1, wherein the chronology object is a calendar.

10. The system of claim 1, further comprising:
said graphic user interface being configured to receive a user-defined project parameter and to display said user-defined project parameter in association with said chronology object; and
said processor being configured to receive any user-defined project parameter and to update the chronology object in substantially real time.

11. A method of managing a project comprising:
providing a plurality of selectable pre-determined project parameters, at least one of said plurality of selectable pre-determined project parameters having an associated follow-up project parameter;
selecting, through a graphical user interface, from amongst said plurality of selectable pre-determined project parameters;
displaying a chronology object; and
displaying, in association with the chronology object, at least selected ones of said plurality of selectable pre-determined project parameters and associated follow-up project parameters; and
updating the chronology object in substantially real time based on said selecting.

12. The method of claim 11, further comprising displaying a display object.

13. The method of claim 12, wherein said display object includes a task manager.

14. The method of claim 12, wherein said display object includes an appointments manager.

15. The method of claim 11, further comprising displaying only those selected ones of said plurality of selectable pre-determined project parameters for which a sub-set of all parties is responsible.

16. The method of claim 11, wherein the project is a transaction.

17. The method of claim 16, wherein the transaction is a real-estate transaction.

18. The method of claim 11, wherein the chronology object is a timeline.

19. The method of claim 11, wherein the chronology object is a calendar.

20. The method of claim 11, further comprising:
receiving a user-defined project parameter and to display said user-defined project parameter in association with said chronology object; and
updating the chronology object in substantially real time.
